(19) United States
(12) Patent Application Publication
(10) Pub. No.: US 2023/0376922 A1
(43) Pub. Date: Nov. 23, 2023

(54) NON-FUNGIBLE TOKEN (NFT) PRESENTATION SYSTEM

(71) Applicants: Jerome Francis Schley Gristina, Charlottesville, VA (US); Baron Crawford Becker, JR., Lynchburg, VA (US)

(72) Inventors: Jerome Francis Schley Gristina, Charlottesville, VA (US); Baron Crawford Becker, JR., Lynchburg, VA (US)

(21) Appl. No.: 18/122,002

(22) Filed: Mar. 15, 2023

Related U.S. Application Data
(60) Provisional application No. 63/320,185, filed on Mar. 15, 2022.

(51) Int. Cl. G06Q 20/14; G06F 21/10

(52) U.S. Cl. CPC G06Q 20/145; G06F 21/1015

(57) ABSTRACT

Methods and systems for presenting digital content associated with a non-fungible-token (NFT). One aspect is a method for presenting a non-fungible token (NFT), the method comprising pairing a user device with an NFT display device, sending a query for one or more NFTs to an NFT delivery system, the NFT delivery system storing an NFT database, each of the one or more NFTs being associated with a digital file, receiving the associated digital files of the one or more NFTs in response to searching the NFT database with the query, receiving inputs selecting a particular NFT associated with a particular digital file from the one or more NFTs and selecting to send the particular NFT to the NFT display device, and sending instructions to the NFT display device to download the particular digital file from an NFT delivery server and display the particular digital file on the NFT display device.

### CROSS-REFERENCE TO RELATED APPLICATION

This application claims the benefit of U.S. Provisional Application Ser. No. 63/320,185, filed on Mar. 15, 2022, the disclosure of which is hereby incorporated by reference in its entirety. To the extent appropriate, a claim of priority is made to the above disclosed application.

### BACKGROUND

Non-fungible tokens (NFTs) are units of data stored on a digital ledger, such as a blockchain. The units of data are associated with digital content stored in digital files. Examples of digital content include photos, videos, audio, GIFs etc. File types are often JPEGs, MP3s, MP4s, MOVs and more. The units of data stored on the ledger provide a public certificate of authenticity and/or proof of ownership. These features are desirable to collectors, and especially digital art collectors. NFT collectors typically use an exchange to purchase an NFT or to trade NFTs.

Existing solutions allow a user to view NFTs available on an exchange. Additionally, there are some existing solutions for viewing the digital file associated with a user's NFT. For example, a user's NFT collection can be viewed on a mobile computing device.

### SUMMARY

In general terms, this disclosure is directed to methods and systems for presenting digital content associated with a non-fungible token (NFT).

One aspect is a method for presenting a non-fungible token (NFT), the method comprising: pairing a user device with an NFT display device; sending a query for one or more NFTs to an NFT delivery system, the NFT delivery system storing an NFT database, each of the one or more NFTs being associated with a digital file; receiving the associated digital files of the one or more NFTs in response to searching the NFT database with the query; receiving inputs selecting a particular NFT associated with a particular digital file from the one or more NFTs and selecting to send the particular NFT to the NFT display device; and sending instructions to the NFT display device to download the particular digital file from an NFT delivery server and display the particular digital file on the NFT display device.

Another aspect is an NFT presentation system comprising: a user device having: at least one processor; and one or more memory devices storing instructions which when executed by the at least one processor to execute a mobile NFT display application; and an NFT display device having: a digital content interface; a processor; and a memory storing instructions which, when executed by the processor, cause the NFT display device to execute a display device application; wherein the user device and the NFT display device are configured to pair by entering a registration code, generated at the NFT display device, at the user device to create an association and registering the association at a NFT delivery system, thereby allowing the user device to send instructions via the NFT delivery system to the NFT display device to display a digital file associated with a selected NFT.

Yet another aspect is An NFT delivery server comprising: at least one processor; a data store with an NFT database storing information for a plurality of NFTs, wherein each NFT is associated with a digital file; and at least one memory device, the at least one memory device storing instructions which, when executed by the at least one processor, cause the NFT delivery server to: receive an NFT query request for the NFT database; search the NFT database with the NFT query request for one or more NFTs; receive a selection request of a particular NFT of the one or more NFTs; and send the digital file associated with the particular NFT to an NFT display device.

Another aspect is a method for presenting a non-fungible token (NFT), the method comprising pairing a user device with an NFT display device, sending a query for one or more NFTs to an NFT delivery system, the NFT delivery system storing an NFT database, each of the one or more NFTs being associated with a digital file, receiving the associated digital files of the one or more NFTs in response to searching the NFT database with the query, receiving inputs selecting a particular NFT associated with a particular digital file from the one or more NFTs and selecting to send the particular NFT to the NFT display device, and sending instructions to the NFT display device to download the particular digital file from an NFT delivery server and display the particular digital file on the NFT display device.

Another aspect is a user device, the user device comprising at least one processor, and one or more memory devices storing instructions which when executed by the at least one processor, cause the user device to pair a user device with an NFT display device, send a query for one or more NFTs to an NFT delivery system, the NFT delivery system storing an NFT database, each of the one or more NFTs being associated with a digital file, receive the associated digital files of the one or more NFTs in response to searching the NFT database with the query, receive inputs selecting a particular NFT associated with a particular digital file from the one or more NFTs and selecting to send the particular NFT to the NFT display device, and send instructions to the NFT display device to download the particular digital file from an NFT delivery server and display the particular digital file on the NFT display device.

Yet another aspect is a method for providing an NFT delivery service, the method comprising receiving an NFT query request for an NFT database storing information for a plurality of NFTs, each of the plurality of NFTs is associated with a digital file, searching the NFT database with the query request for one or more NFTs, receiving a selection request of a particular NFT of the one or more NFTs, and sending the digital file associated with the particular NFT to an NFT display device.

Another aspect is an NFT delivery server comprising at least one processor, a data store with an NFT database storing information for a plurality of NFTs, wherein each NFT is associated with a digital file, and at least one memory device, the at least one memory device storing instructions which, when executed by the at least one processor, cause the NFT delivery server to receive an NFT query request for the NFT database, search the NFT database with the query request for one or more NFTs. receive a selection request of a particular NFT of the one or more NFTs, and send the digital file associated with the particular NFT to an NFT display device.

Yet another aspect is a method for presenting an NFT, the method comprising receiving a command from a user device to connect to a network, accessing an NFT delivery server via the network, receiving a request to download a digital file associated with an NFT, and downloading and displaying the digital file on a connected display device.

Another aspect is an NFT display device comprising a digital content interface a processor, and a memory storing instructions which, when executed by the processor, cause the NFT display to receive a command from a user device to connect to a network, access an NFT delivery server via the network, receive a request to download a digital file associated with an NFT, and download and display the digital file on a connected display device.

### BRIEF DESCRIPTION OF THE DRAWINGS

FIG. 1 illustrates an example NFT presentation system, in accordance with some embodiments of the present disclosure.

FIG. 2 illustrates an example NFT display device, in accordance with some embodiments of the present disclosure.

FIG. 3. illustrates an example NFT delivery system, in accordance with some embodiments of the present disclosure.

FIG. 4 illustrates an example user device, in accordance with some embodiments of the present disclosure.

FIG. 5 illustrates an example method for presenting an NFT, in accordance with some embodiments of the present disclosure.

FIG. 6 illustrates an example method for connecting with an NFT display device, in accordance with some embodiments of the present disclosure.

FIG. 7 illustrates an example method for providing an NFT delivery service, in accordance with some embodiments of the present disclosure.

FIG. 8 illustrates an example method for compiling keywords for an NFT database, in accordance with some embodiments of the present disclosure.

FIG. 9 illustrates an example method for presenting a digital file associated with an NFT, in accordance with some embodiments of the present disclosure.

FIG. 10 illustrates an example system flow diagram, illustrating a method for presenting an NFT, in accordance with some embodiments of the present disclosure.

FIG. 11 illustrates an example user interface for a home page of the mobile NFT display application, in accordance with some embodiments of the present disclosure.

FIG. 12 illustrates an example user interface for a pair page of the mobile NFT display application, in accordance with some embodiments of the present disclosure.

FIG. 13 illustrates an example user interface for a search page of the mobile NFT display application, in accordance with some embodiments of the present disclosure.

FIG. 14 illustrates an example user interface for a display page of a selected NFT as part of the mobile NFT display application, in accordance with some embodiments of the present disclosure.

FIG. 15 illustrate example user interfaces showing the navigation between the search page and display page, as part of the mobile NFT display application, in accordance with some embodiments of the present disclosure.

FIG. 16 illustrates an example method for registering an NFT display device, in accordance with some embodiments of the present disclosure.

FIG. 17 illustrates an example user interface of the display device application.

FIG. 18 illustrates an example user interface of the display device application for registering an NFT display device, in accordance with some embodiments of the present disclosure.

FIG. 19 illustrates an example user interface of the mobile NFT display application for registering an NFT display device, in accordance with some embodiments of the present disclosure.

FIG. 20 illustrates an example user interface of the mobile NFT display application, in accordance with some embodiments of the present disclosure.

FIG. 21 illustrates an example user interface for selecting a registered NFT display device to send a present NFT request, in accordance with some embodiments of the present disclosure.

FIG. 22 illustrates an example user interface for entering an NFT search query, in accordance with some embodiments of the present disclosure.

FIG. 23 illustrates an example method for displaying digital files associated with an NFT that are optimized for a display configuration, in accordance with some embodiments of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general terms, this disclosure is directed to methods and systems for presenting digital content associated with a non-fungible token (NFT). In some embodiments, a mobile application allows a user to search and select an NFT. The digital file associated with the selected NFT is downloaded at the NFT display device and presented on a connected display. This allows a user to control and present NFTs on a device optimized to present the digital file associated with the NFT. For example allowing the user to present a video associated with an NFT on a television or image as output from a projector.

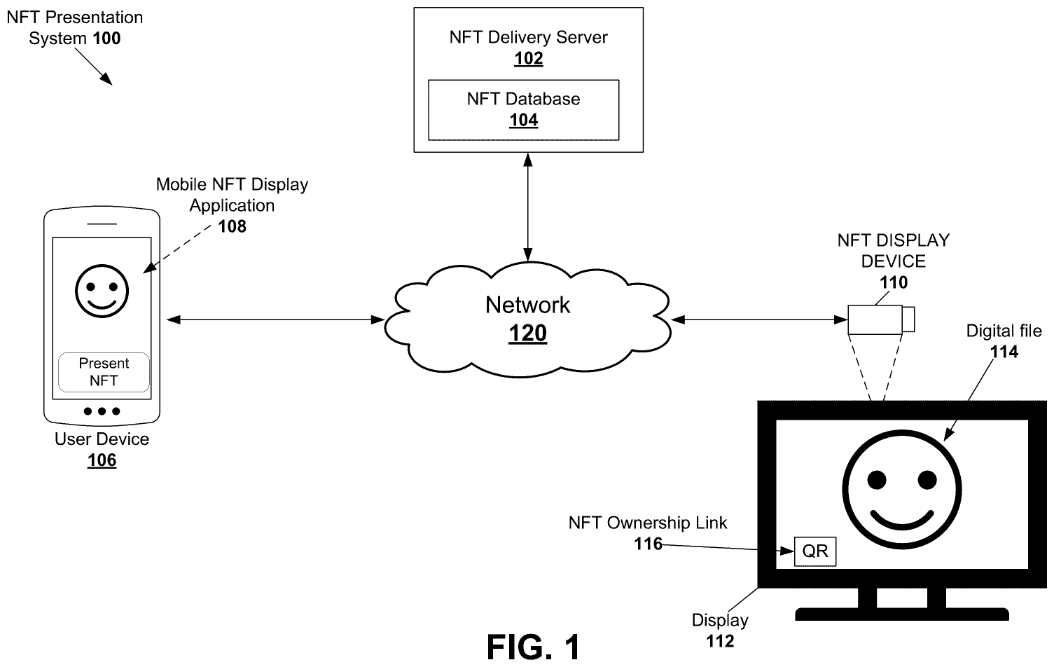

FIG. 1 illustrates an example NFT presentation system 100. The NFT presentation system 100 includes an NFT delivery server 102 with an NFT database 104, a user device 106 executing a mobile NFT display application 108, and a NFT display device 110 connected to a display 112, the display 112 presenting a digital file 114 with an overlayed NFT ownership link 116. A network 120 is also shown.

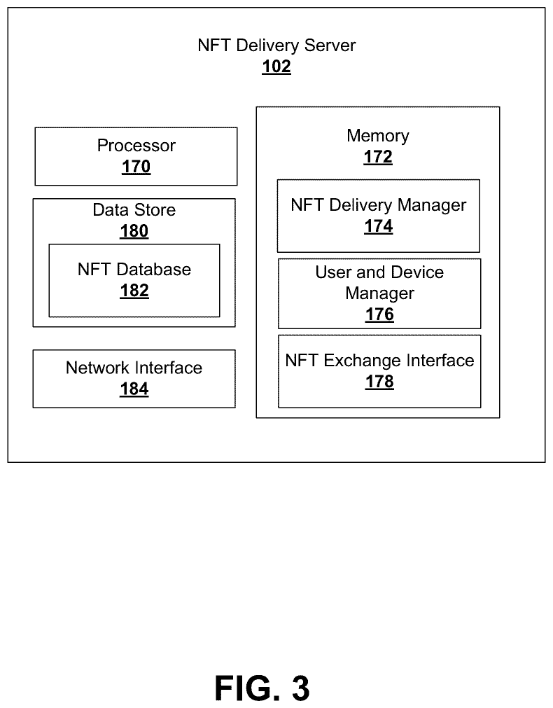

The NFT delivery server 102 operates to provide services for the NFT presentation system. The NFT delivery server 102 includes an NFT database 104. The NFT database stores NFTs with associated information. Examples of NFT information include NFT name, NFT creator, NFT creation date, initial owner user name, current owner user name, historical list of NFT owners, historical dates and prices (if applicable) of NFT transfers, associated exchange(s), keywords, etc. In some embodiments, NFT delivery server stores associations between a user device or a user accounts and NFT display devices. The NFT can send and receive data messages from the user device 106. For example, the NFT delivery server, can communicate with the user device 106 to receive a query for the NFT database 104 and provide the results. Additionally, the NFT delivery server may receive a present NFT request from the user device. The NFT delivery server 102 is further configured to communicate with the NFT display device. In some embodiments, a digital file 114 associated with a selected NFT is downloaded on the NFT display device 110 from the NFT delivery server 102. In some embodiments, the NFT delivery system receives a link to a collection associated with the owner the selected NFT and encodes the link or provides the link to be encoded by the NFT display device into a machine readable code (e.g., a QR code). In some embodiments, NFT delivery server stores associations between a user device or a user accounts and NFT display devices. For example, each user may have an account which is associated with one more NFT display devices. An example of the NFT delivery server 102 is illustrated and described in reference to FIG. 3.

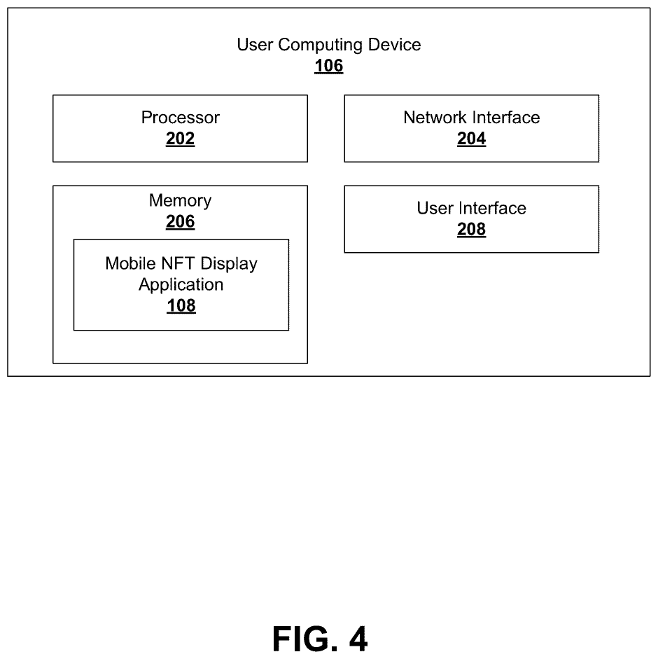

The user device 106 operates a mobile NFT display application 108 which allows a user to utilize the various features of the NFT presentation system 100. The user device 106 can be any of a variety of computing devices, such as a smart phone, tablet, laptop, desktop, smart watch, etc. In some embodiments, the mobile NFT display device application is used to receive user inputs used for pairing with an NFT display device. Additionally, the mobile NFT display application 108 receives inputs to query the NFT delivery system for one or more NFTs. In some embodiments, information for NFTs are stored on the user device 106 and accessible by the mobile NFT display application 108. The mobile NFT display application 108 receives a user selection to present an NFT on the display 112 and sends this request to the NFT delivery server 102. In other embodiments, the present NFT request is sent directly to the NFT display device. The user device 106 is illustrated and described in reference to FIG. 4.

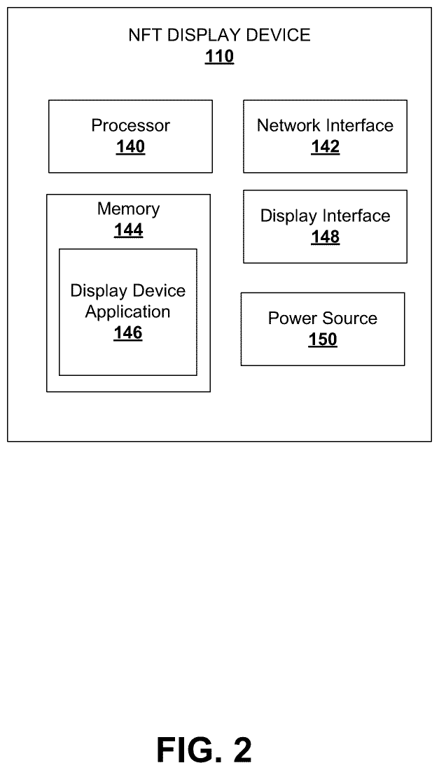

The NFT display device 110 is configured to interface with a display 112 to present a digital file 114 associated with an NFT. In typical embodiments, the NFT display device 110 is in digital communication with the NFT delivery system and the user device 106. In some embodiments, once an NFT is set to display the NFT display device will download the digital file 114 associated with the NFT and display the digital file 114 on the connected display. IN some embodiments an NFT ownership link 116 is also presented on the display. The NFT ownership link 116 can be used to link to a collection of the owner of the current NFT displayed. In some embodiments, the QR code links to a service which compiles information related to an NFT, for example a service such as Etherscan.io. An example of the NFT display device is illustrated and described in reference to FIG. 2.

The display can be any media output device which is able to present the digital file. Examples of the display include TVs, monitors, projectors, speakers, holographic display devices, etc. In alternative embodiments, the NFT display device is built into the display or an NFT display device application is downloaded as part of the display (e.g., a display such as a smart TV).

The network 120 operates to connect the NFT delivery server 102, the user device 106, and the NFT display device 110. In some embodiments, the network 120 is a public network such as the Internet. In some embodiments, the user device 106 first connects with the NFT display device 110 over a first wireless network or a wireless protocol to provide credentials to connect the NFT display device 110 to a local Internet Access point (e.g., a local Wi-Fi network). An example of the first wireless network includes a cellular network and an example of the wireless protocol includes BLUETOOTH®.

FIG. 2 illustrates an example NFT display device 110. The NFT display device 110 includes a processor 140, a network interface 142, a memory 144, a display interface 148, and a power source 150.

The processor 140 executes instructions for the NFT display device 110. Including instructions stored in the memory 144, such as instructions included in the display device application 146. The processor is electrically connected to the memory 144, the network interface 142, and the display interface 148.

The network interface 142 operates to interface with one or more networks. In some embodiments, the NFT display device includes a cellular interface and a wi-fi interface. The cellular interface is used to receive messages over a cellular network. In some embodiments, these messages include information which allow the NFT display device to connect to a wi-fi network. Once connected the NFT display device uses the wi-fi network to communicate with an NFT delivery server.

In some embodiments, the memory stores instructions to execute a display device application 146. The display device application 146 may include instructions to periodically, check with the NFT delivery server to determine if a new NFT is set to display. When an NFT is set to display the display device application 146 includes instructions to download the digital file associated with the NFT output the digital file to a connected device via the display interface 148. In some embodiments, the display device application 146 may encode a link which is associated with all/either/or the creator, the owner, the exchange of the NFT set to display.

The display interface 148 interfaces with a connected device to output a desired display. In typical embodiments, the display interface 148 is an HDMI or micro-HDMI interface.

The power source 150 provides power for the NFT display device. In some embodiments, the power source 150 is a battery. In other examples, a cable connects an external power source to the NFT display device. For example, a cable may connect with an outlet or from the connected display device (e.g., via a USB or micro-USB cable).

In some embodiments, the NFT display device is a streaming TV device which is capable of downloading and installing the display device application 146. In some embodiments the streaming TV device is a computing device connected to a display device (e.g., via an HDMI cable). In some embodiments, the NFT display device is integrated within a TV (e.g., a smart TV).

FIG. 3. Illustrates an example NFT delivery server 102. The NFT delivery server 102 includes a processor 170, a memory 172, a data store 180, and a network interface 184.

The processor 170 executes instructions for the NFT delivery server 102. Including instructions store in the memory 172, such as the instructions included in the NFT delivery manager 174, the user and device manager 176, and the NFT exchange interface 178.

In the example shown, the memory 172 stores instructions to execute an NFT delivery manager 174, a user and device manager 176, and an NFT exchange interface 178.

The NFT delivery manager 174 operates to query the NFT database 182 when a query request is received and provide the results to the requesting user device. Additionally, the NFT delivery manager 174 sets an NFT to display on a selected NFT display device when an NFT selection and an NFT display request are received from a user device. The NFT delivery manager 174 operates with the NFT display device to prepare and provide a digital file associated with a selected NFT to the NFT display device.

The user and device manager 176 operates to pair user devices or user accounts with NFT display devices. For example, once an NFT display device connects to the NFT delivery server the user device which paired the NFT display device is stored and associated with the NFT display device. The user and device manager 176 allows the NFT delivery server to provide the NFT selected by a user on the correct NFT display device or multiple devices.

The NFT exchange interface 178 operates to allow communication with various NFT exchanges. For example, some features may require the NFT delivery server to retrieve NFT information, including current ownership information, from a connected NFT exchange. Additionally, the NFT database 182 may use the NFT exchange interface to retrieve additional NFT information.

The data store 180 hosts an NFT database 182. The NFT database 182 stores information for a plurality of NFTs. In some embodiments, the NFT database 182 retrieves NFTs from specific exchanges as users send requests for specific NFT's from exchanges. This allows the NFT database 182 to grow to include NFT's of interest to the user. Information included in the NFT database include digital file data, NFT name, creator, exchange NFT was traded on, mint date, drop date, original price, original buyer, blockchain code or address, owner history, price history, comments, likes, dislikes, and keywords.

The network interface 184 operates to allow the NFT delivery server 102 to communicate with a plurality of computing devices including user devices, NFT display devices, and NFT exchange servers and to utilize various third party services.

In some embodiments, the NFT delivery server 102 tracks the number of views for each of the NFTs stored at the NFT database 182. The NFT delivery server may include a service which provides payment to an owner of the NFT based on the number of views for the NFT. In some embodiments, the payment is provided using a blockchain currency technology (e.g., Ethereum). In some embodiments, payment is provided each time an NFT receives views above a threshold (e.g., per one thousand views).

In some embodiments, the NFTs stored in the NFT database 182 are annotated with tags and keywords. Examples of tags include: “gallery” indicating that the NFT is accessible to default users on NFT display devices, “metafeatured” for sponsored placement, “tvoptimized” indicating the digital file includes dimensions that generally fit well on a horizontal oriented TV, “vertical” indicating the content is optimal for displayed on a vertical display, “horizontal” indicating the content is optimal for display on a horizontal display, and “cropped4tv” indicating the content is modified to fit on a TV full screen. In some embodiments, the tags correspond to a theme including “office”, “party”, “cars”, “explicit” (by default now allowable with the “gallery” tag), “abstract”, “photo”, “mixmed”, “print”, “illustration”, “satire”, etc.

FIG. 4 illustrates an example user device 106. The user device 106 includes a processor 202, a network interface 204, a memory 206, and a user interface 208.

The processor 202 executes instructions for the user device 106. Including instructions stored in the memory 206, such as instructions included in the mobile NFT display application 108. The memory 206 also stores and operates an operating system for the user device.

In some embodiments the mobile NFT display application 108 is a mobile application such as an iOS or android application. The mobile NFT display application 108 receives user inputs to perform various functions describe herein. In some embodiments, the mobile NFT display application 108 outputs information on the user interface 208. For example, information for pairing with an NFT display device, query for one or more NFTs, select an NFT to display, and to send an NFT display request.

The network interface 204 operates to allow the user device 106 to communicate with other computing systems and devices, such as the NFT display device, and the NFT delivery system.

The user interface 208 operates to present information to a user and receive inputs. In some embodiments, the user interface includes an output/input device, such as touch screen.

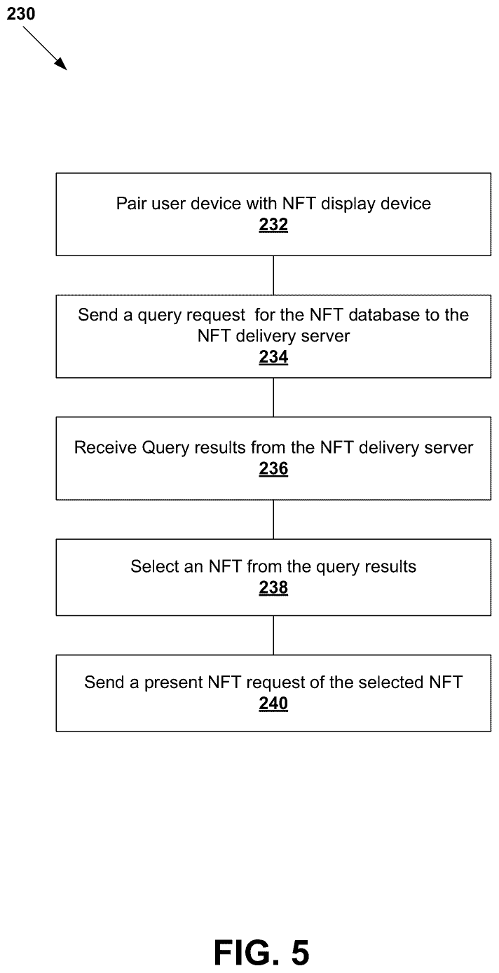

FIG. 5 illustrates an example method 230 for presenting an NFT. The method 230 is executed on the user device 106 as part of the mobile NFT display application 108, as shown in FIG. 1. The method 230 includes the operation 232, 234, 236, 238, and 240.

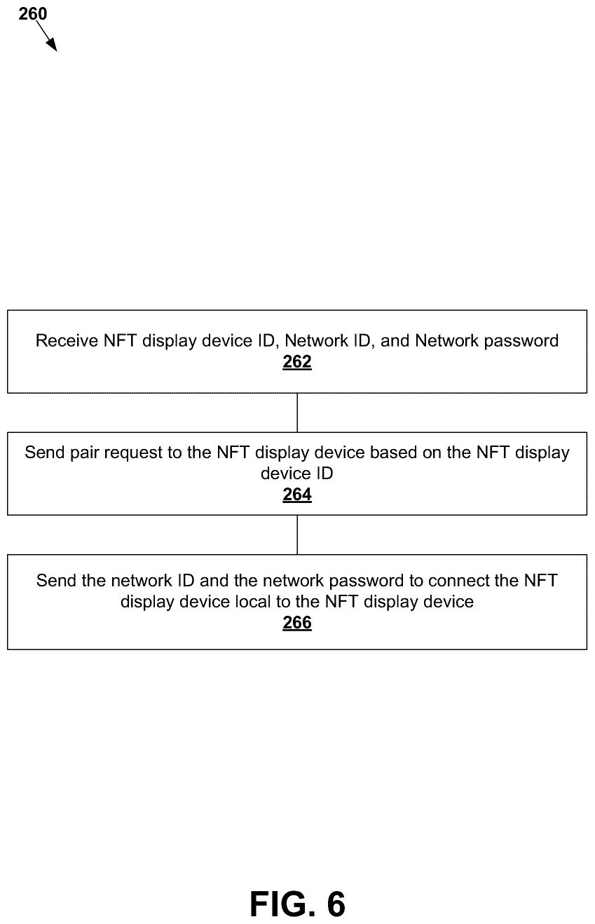

The operation 232 pairs the user device with the NFT display device. In some embodiments, the pairing process includes connect the NFT display device to a local access point for a network (e.g., a Wi-Fi network connected). In some embodiments, the NFT display device includes a specific network component for the initial pairing process and a second network component to use once paired. For example, the initial component can include a cellular network module (e.g., 3G modem) which receives network credentials (e.g., ID and password) for a second network. Once connected to the second network, the NFT display device communicates with an NFT delivery system which pairs the NFT display device with the user device. An example method 260 for pairing the user device with an NFT display device is illustrated and described in reference to FIG. 6.

The operation 234 sends a query request to the NFT database to the NFT delivery system. In some embodiments, the user device displays a user interface which allows the user to enter a query for one or more NFT's of interest. For example, a user can search for an NFT by username, name of the NFT, marketplace, and/or by keyword.

The operation 236 receives a query result from the NFT delivery server. In some embodiments, the results include one or more NFTs. The digital file associated with each of the NFTs in the results can be displayed to a user. For example, a user can scroll vertically or horizontally to view the digital files associated with the NFT in the results.

The operation 238 selects an NFT from the query results. A user can select an NFT which the user would like to present on the display. In some embodiments, the user selects an NFT by having the digital file displayed and selecting an input to present the NFT at the operation 240.

The operation 240 sends a present NFT request of the selected NFT to the NFT delivery server. The NFT delivery server will then mark the NFT to display which will trigger the NFT display device to download the digital file associated with the NFT from the NFT delivery server. In alternative embodiments, the present NFT request is sent to the NFT display device which triggers the NFT display device to download the digital file associated with the NFT from the NFT delivery server.

FIG. 6 illustrates an example method 260 for pairing a user device with an NFT display device. In some embodiments, the method 260 is executed on the user device 106 as part of the mobile NFT display application 108, as shown in FIG. 1. The method 260 includes the operation 262, 264, and 266.

The operation 262 receives a NFT display device ID, a network ID for a network local to the NFT display device, and a network password for the network local to the NFT display device. In some embodiments, the operation 262 receives this information from a user entering the details on a user interface of the user device.

The operation 264 sends a pair request to the NFT display device based on the NFT display device ID. In some embodiments, the pair request is sent to the NFT display device over a cellular network. In some embodiments, the pair request is sent using Bluetooth. In some embodiments, the NFT display device ID and the user account ID are sent to the NFT delivery server which stores an association between the NFT display device and the user account. In some embodiments, a user manually inters the NFT display device ID on the user device. In other embodiments, a user scans a machine readable code, such as bar code or a QR code which contains the NFT display device ID.

The operation 266 sends the network ID and the network password to connect the NFT display device to a network local to the NFT display device. In some embodiments, the NFT display device is connected to the NFT delivery server by connecting the NFT display device to a local access point such as a local wi-fi network. The credentials for this access point are sent to the NFT display device as part of the pairing process.

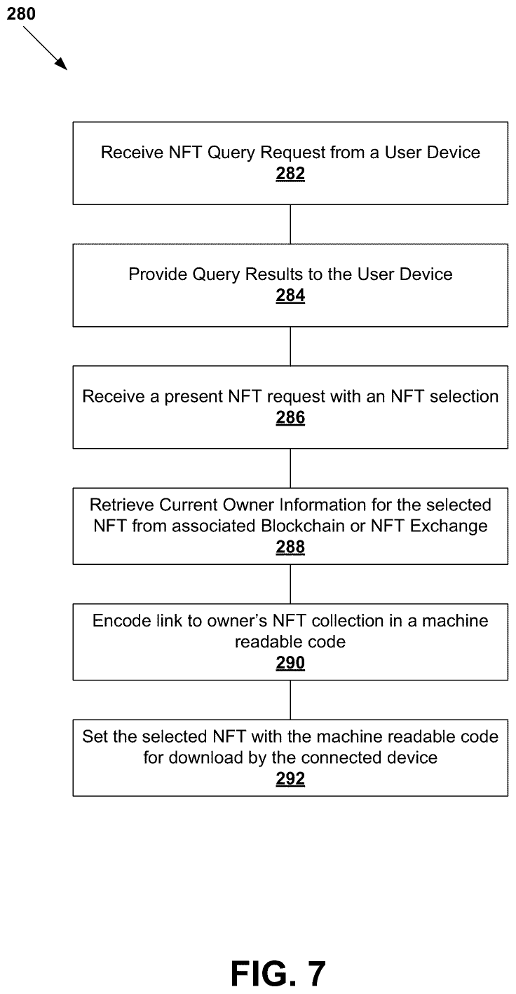

FIG. 7 illustrates an example method 280 for providing an NFT delivery service. In some embodiments, the method 280 is executed on the NFT delivery server 102, as shown in FIG. 1. The method 280 includes the operation 282, 284, 286, 288, 290, and 292.

The operation 282 receives an NFT query request from a user device. In some embodiments, the query can of two types. The first type includes either an owner name or an NFT name and specific exchange the NFT is present on. This allows the NFT delivery server to retrieve the NFT from the correct exchange. In some embodiments, once the NFT delivery server retrieves a new NFT it is stored locally the NFT database stored at the NFT delivery server. A second type of query includes a keyword query. In this type of query the database is searched by keyword and each matching NFT is provided to the user as part of the query results. In some embodiments, the query can be in a variety form and the NFT delivery server will first search the NFT database for results, and, if necessary, search connected exchanges for matching results. In some embodiments, searching connected exchanges is done via an API provided by the corresponding exchange. Additionally or alternatively, web crawling techniques can also be used to search NFT exchanges.

The operation 284 provides query results to the user device. In some embodiments, the query results include a single NFT, in other examples the query results include a plurality of NFTs. The NFT delivery server provides the results to the user device, typically, by sending information about the NFTs in the results including the associated digital file.

The operation 286 receives a present NFT request with an NFT selection. The present NFT request with an NFT selection are received from a user device. The NFT delivery server marks the selected NFT to set at the corresponding NFT display device. In some embodiments, the corresponding NFT display device is determined based on the user device ID or a user account associated with the request. In other embodiments, the present NFT request includes a selection of a specific NFT display device. For example, if the user has multiple NFT display devices associated with an account the user can select one or more of the multiple NFT display devices to present the NFT.

The operation 288 receives current owner, and other relevant curation, information for the selected NFT from an associated blockchain or an NFT exchange. In some embodiments, the current owner can be retrieved from an exchange. In other examples, the owner information can be retrieved from the blockchain storing the chain of ownership for the NFT. If the current owner has associated collection of NFTs a link connecting to this collection is retrieved.

The operation 290 encodes the link to the owner's NFT collection in a machine readable code. An example of a machine readable code includes a quick response (QR) code. In some embodiments, the operation 290 is performed at the NFT display device. The machine readable code is presented in a non-obtrusive manner to provide information to viewers who can scan the code to view the owners collection. If current owner is the creator, then the machine readable code refers to the creator or the exchange or gallery promoting the creator and his/her collection.

The operation 292 sets the selected NFT with the machine readable code for download by the connected device. The NFT display device periodically checks and when a NFT is set to display the NFT delivery server provides the NFT for download by the NFT display device.

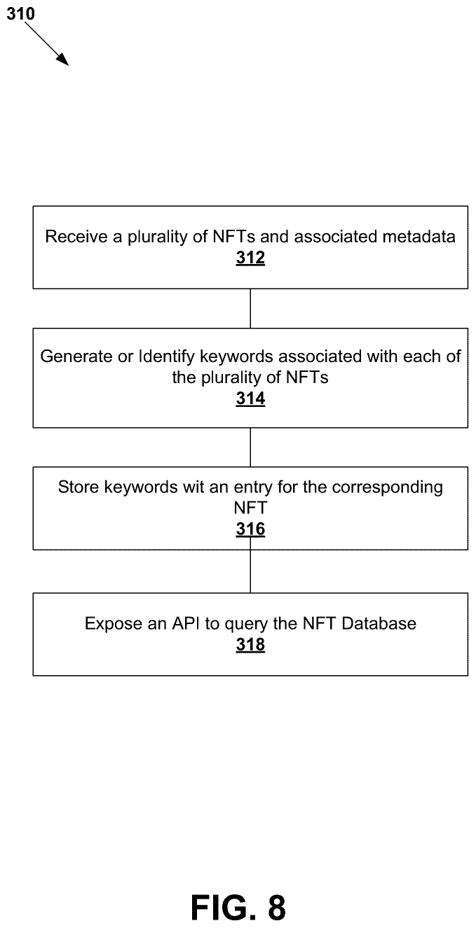

FIG. 8 illustrates an example method 310 for compiling keywords for an NFT database. In some embodiments, the method 310 is executed by the NFT delivery server 102, as shown in FIG. 1. The method 310 includes the operations 312, 314, 316, and 318.

The operation 312 receives a plurality of NFTs each with associated metadata. In some embodiments, this information is received from an NFT exchange via an API or using a web scrapping technique. In some embodiments, this information is retrieved directly from a user's collection.

The operation 314 generates keywords. In some embodiments, the keywords are generated for each NFT using computer vision to process the digital file associated with the NFT. For example, the computer vision algorithm may detect features and categories in the images which include a corresponding keyword. For example, the computer vision algorithm may process a digital file and determine it displays an image of an animal or that the digital file includes features which indicates that it belongs to a certain category or collection of NFTs. The computer vision algorithm can be implemented to associate these detected features with keywords.

In some embodiments, machine learning techniques are used to generate keywords. For example, a machine learning mode can be trained to detect features based on the input NFT information and digital file. The training processes can include inputting training NFTs with labeled keywords to map the NFT information with different keywords. Supervised and unsupervised machine learning techniques can be used.

In some embodiments, web scrapping techniques are used to identify key words for an NFT. For example, web pages with the NFT name can be craped to identify key words associated with the NFT. In some embodiments, NFT exchange pages describing the NFT can be scrapped.

Additionally, the associated metadata can be processed to identify keywords. For example, a keyword may include a specific year an NFT was created, this date may be retrieved automatically from the metadata.

In addition, to the automatic processes described above for generating keywords, manual processes can be used. For example, a user can input keywords for the NFT.

After the keywords are generated or identified, the operation 316 stores the keywords with an entry for the corresponding NFT and the operation 318 exposes an API too allow the mobile NFT display application operating on a user device to interface and query the NFT database.

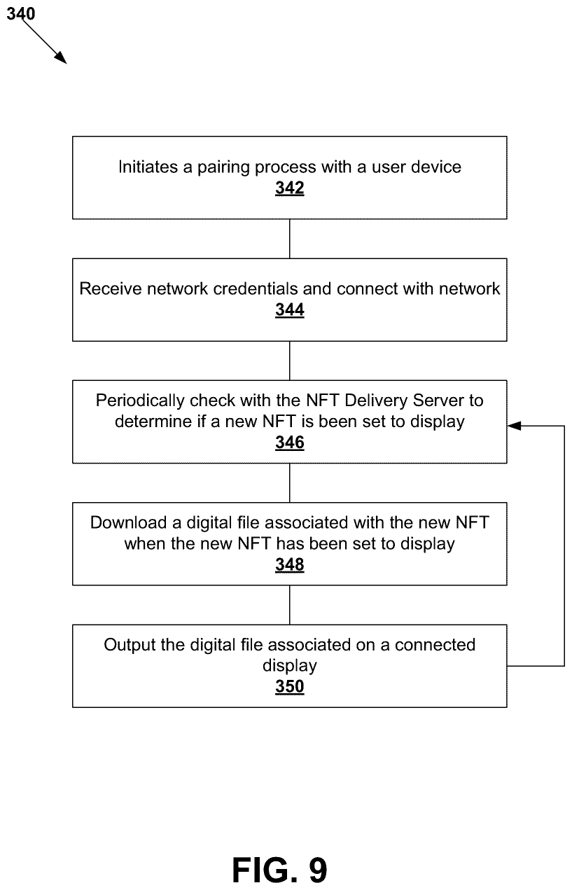

FIG. 9 illustrates an example method 340 for presenting a digital file associated with an NFT. In some embodiments, the method 340 is executed on the NFT display device 110, as shown in FIG. 1. The method 340 includes the operations 342, 344, 346, 348, and 350.

The operation 342 initiates a pairing process with a user device. In some embodiments, initiating a pairing process includes receiving a command from a user device. In some embodiments, the command is received over a cellular network. In some embodiments, the command received using a wireless protocol. For example, the command can be sent using BLUETOOTH®.

The operation 344, receives network credentials and connects with a network. As part of the pairing process the operation 344 connects the NFT display device to a network. In some embodiments, the NFT display device connects to a local network that provide access to a public network, such as the Internet. In some embodiments, the network credentials include a network ID and a network password. The network credentials are used to gain access to the network. Once connected to the network, the NFT display device connects with the NFT delivery server.

The operation 346 periodically checks with the NFT delivery server to determine if an NFT is set to display. When an NFT is set to display, the method 340 continues to the operation 348. The operation 346 continues to check the NFT delivery server to detect when a different NFT is set to display and initiate the operations 348 and 350 with the different NFT.

The operation 348 downloads a digital file associated with the new NFT when the new NFT is set to display. In some embodiments, other features of the NFT are downloaded, for example ownership details, or a link to an owner's collection. These features can be overlayed over a portion of the digital file to provide access to a user viewing the NFT. In some embodiments, the features are delivered via a link which is encoded in a machine readable-code (e.g., a QR code).

Once downloaded, the operation 350 outputs the digital file associated with the new NFT on a connected display. In some embodiments, the NFT display device is connected to the display via a media digital content interface, such as an audio/visual interface (e.g., HDMI).

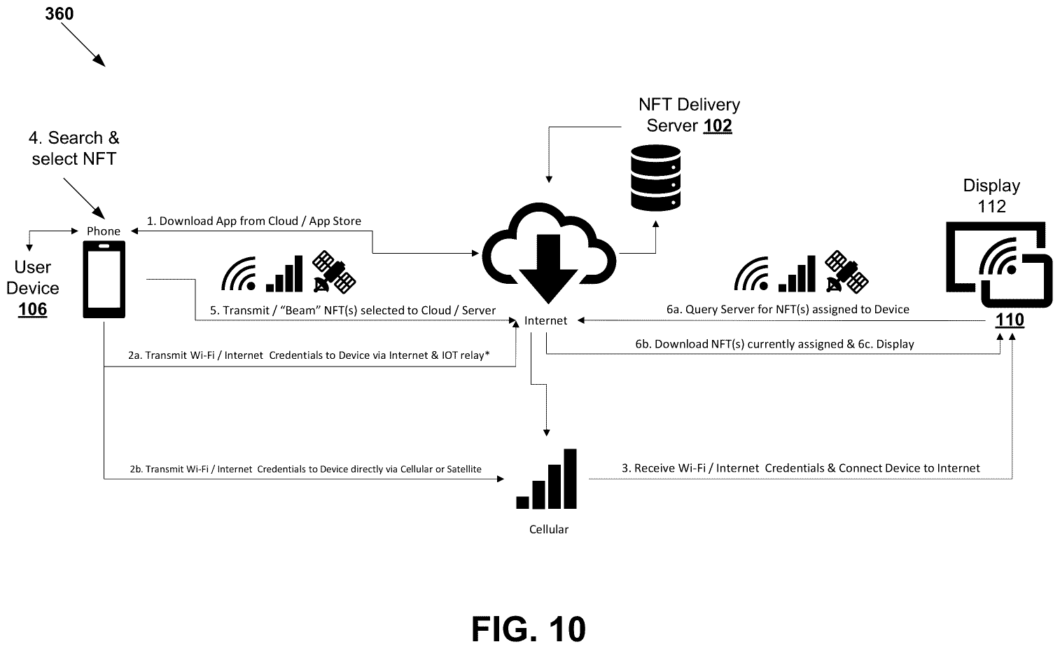

FIG. 10 illustrates an example system flow diagram, illustrating a method 360 for presenting an NFT. The example shown includes, an NFT delivery server 102, a user device 106, a NFT display device 110, and a display 112, examples of each are illustrated and described herein.

In the example method 360, an NFT display application is downloaded to the user device 106 from a website or application platform, at step 1. Next, the user device 106 pairs with the NFT display device 110. In some embodiments, when a user opens the application, the user is promoted to enter an identification number for the NFT display device 110, along with a Wi-Fi network ID and a Wi-Fi password. The network ID and password are transmitted to the NFT display device 110 either directly (step 2b) or indirectly using an intermediate IoT Relay service (step 2a). Typically, the NFT display device 110 includes a cellular modem (e.g., a 3G model which can receive the initial request before connecting to local network access point (e.g., a local Wi-Fi network. This allows the user device 106 to connect with the NFT display device 110 at any location. In some embodiments, the pairing process uses a local protocol, such as Bluetooth. At step 3, the NFT display device receives a local network credentials and connects to the network. At step 4 a user searches and selects an NFT. Examples for searching and selecting an NFT are described herein. For example, a user can search by the owners user name, NFT's name, name of an NFT exchange or by entering keywords. Next the user can present the NFT on the display 112 via the NFT display device 110. When an input at the user device 106 selecting an NFT to display is received the user device 106 transmits the request to the NFT delivery server 102 (at step 5). For example, the FNT ID number can be sent to the NFT delivery server. Based on the user device 106 which sends the request the NFT delivery server will set the NFT to display on the paired NFT display device 110. In some embodiments, the user device 106 will further transmit which NFT display device 110 to display the NFT (e.g., if the user has multiple NFT display devices). In the example shown, at step 6a. the NFT display device 110 periodically (e.g., once every 60 seconds) checks with the NFT delivery server 102 to check if a NFT has been set to display. If at step 6a an NFT is set to display, then at step 6B the NFT is downloaded to the NFT display device and presented on the display 112 at the step 6c.

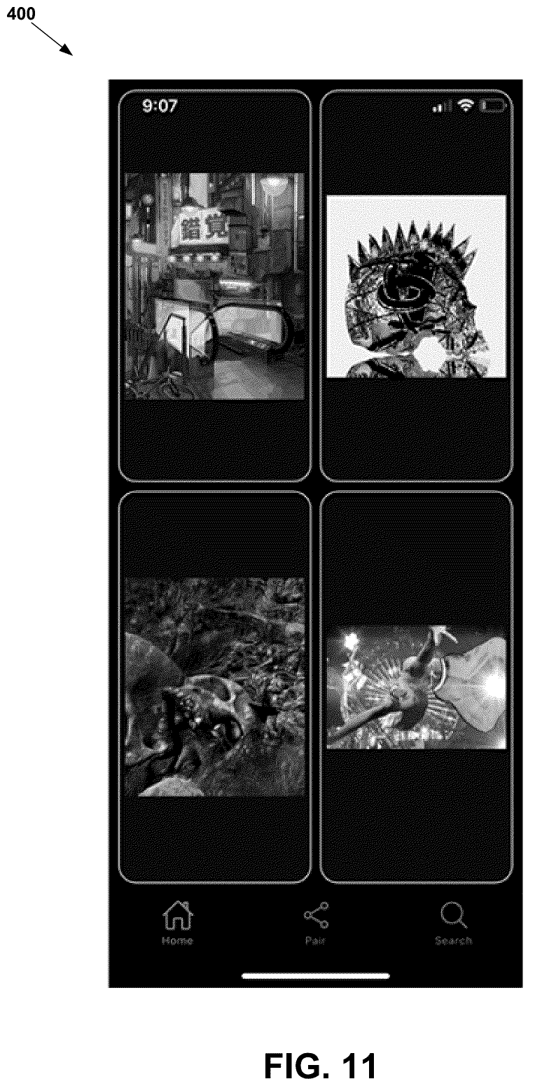

FIGS. 11-15 illustrate various example user interfaces for the mobile NFT display application. For example, the user interfaces can be displayed on the user device 106 in the examples illustrated and described in FIG. 1 and FIG. 4. Although specific user interfaces are shown, many other user interfaces with analogous features are included within the scope of this disclosure.

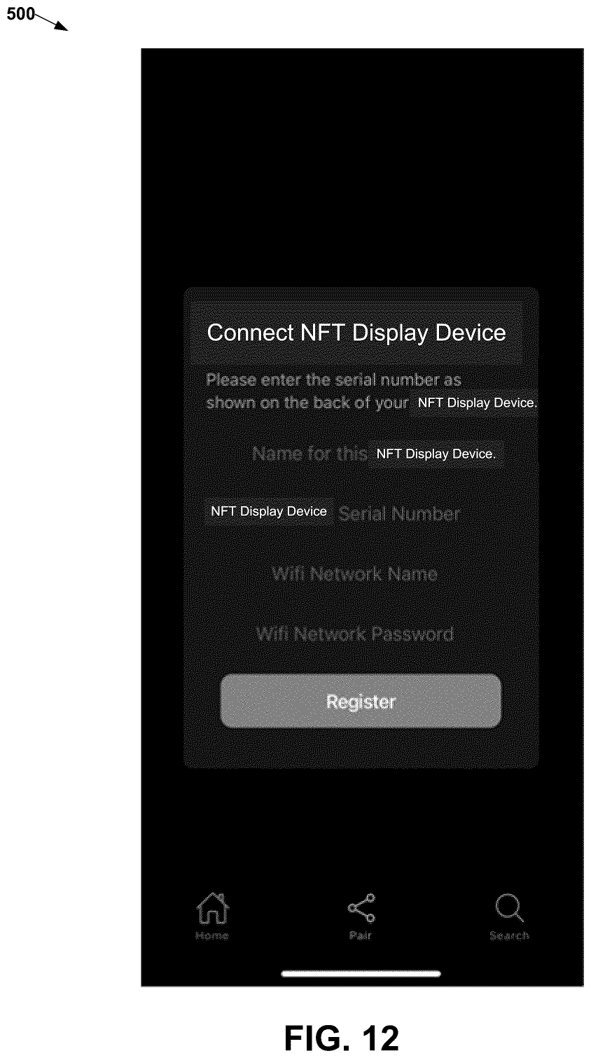

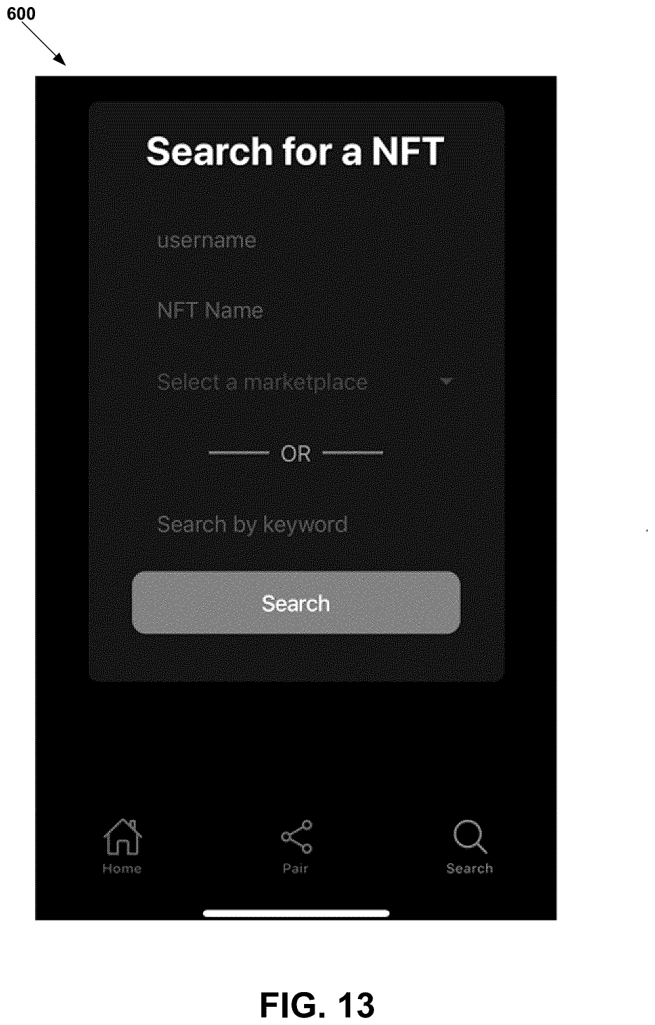

FIG. 11 illustrates an example user interface 400 for a home page of the mobile NFT display application. In some embodiments, the home page displays a plurality of digital content of digital files associated with NFTs. In the example shown, the digital content of four different NFT's are shown. However, any different number of NFTs can be displayed as part of the home page. For example, the digital content of 1 NFT, 2 NFTs, 4 NFTs, 20 NFTs, etc. can be displayed in different embodiments. In some embodiments, the NFTs displayed at the home page are randomly selected from a collection of NFTs. In other embodiments, the NFTs are selected based on the viewing history of the user. In some embodiments, a user can select which NFTs to display on the home page. On the bottom of the home page is a navigation bar 402 which allows a user to select a tab to view different pages. For example, a pair tab allows a user to view a pair page (e.g., shown in FIG. 12 as the user interface 500), and the search pair tab to view a search page (e.g., shown in FIG. 13 as the user interface 700). In some embodiments, when a user first launches the mobile NFT display application the user interface 400 is displayed to a user.

FIG. 12 illustrates an example user interface 500 for a pair page of the mobile NFT display application. The user interface 500 includes several fields for receiving inputs from a user. In the example shown, the fields include a name the user provides for the NFT display device, a serial number of the NFT display device, a Wi-Fi network name (e.g., Wi-Fi network ID), and a Wi-Fi network password. The user provides the NFT display device name to allow the user to identify a particular display device, the serial number is used to identify and connect with the NFT display device. For example, the serial number can be associated with an address which is used to establish data communication between the user device and the NFT display device. The Wi-Fi network name and Wi-Fi network password are sent to the NFT display device to connect the NFT display device to the Wi-Fi network. After the user enters the information in the fields the user clicks the register button and, in response to the selection, the user device attempts to pair with the NFT display device. In some embodiments a message is displayed on the user interface 500 to notify the user if the pairing process was successful or not. Also shown is a navigation bar which operates similar to the navigation bar described in FIG. 11.

FIG. 13 illustrates an example user interface 600 for a search page of the mobile NFT display application. In the example show, the search page includes fields for doing two different types of search. To execute a search a user enters information into one or more of the fields an selects the search button. Other search fields can be used in addition or alternatively to the fields shown. Also shown is a navigation bar which operates similar to the navigation bar described in FIG. 11.

The first type of search includes fields for a username, an NFT name, and a select NFT marketplace. If desired by a user, the username field can be input with a username of an owner of one or more NFTs of interest. A search can be conducted with that user name at all connected marketplaces, or at a specific market place selected by the user at the select NFT marketplace field. Similarly, a user can search by an NFT name by entering a name in the NFT name field. In some embodiments, different combinations of the username, NFT name, and select NFT market place fields can be entered to perform a search. In other embodiments, the select market place field must be selected along with one of or both of the user name and NFT name fields. In some embodiments, the select NFT market place field includes a drop down menu of all NFT marketplaces accessible by the mobile NFT display application. In some embodiments, the first type of search first queries at the NFT database 104 at the NFT delivery server 102 and, if one or more matches are not found, the NFT delivery server will send the query to the selected marketplace or a plurality of connected NFT marketplaces. If the NFT database 104 does not have at least one match for the query but the query returns one or more matches form a corresponding NFT marketplace, the NFT delivery server will download and store the NFT information for the one or more matches returned from the corresponding NFT marketplace.

The second type of search is a keyword search. In some embodiments, a user can enter one or more keywords which are sent to the NFT delivery server 102 to query the NFT database for one or more NFTs associated with the one or more entered keywords. Example keywords include types of scenes, objects in a scene (e.g., animals or trees), genre of NFT, etc. In some embodiments, a single keyword is used. In some embodiments, the keyword field is limited by a number of characters.

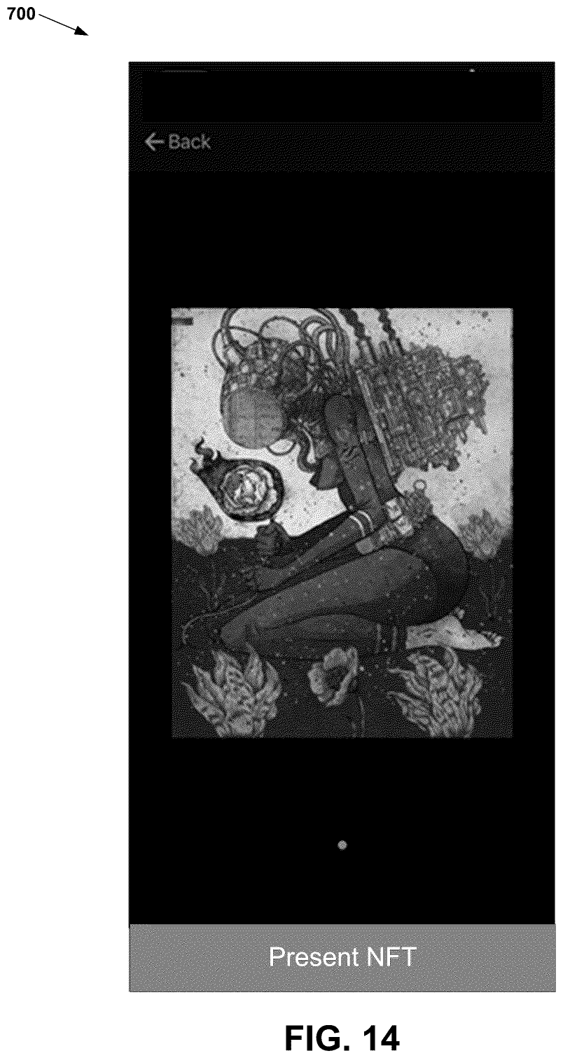

FIG. 14 illustrates an example user interface 700 for a display page of a selected NFT as part of the mobile NFT display application. The display includes a back input which navigates the user back to the search page (e.g., the user interface 600 shown in FIG. 13). The user interface 700 further includes a section for displaying the digital content associated with the NFT. In the example show, only a single NFT is displayed and returned. In alternative embodiments, multiple dots are presented below the digital content corresponding to different NFTs a user can navigate via a gesture (e.g., a swipe received by a touch screen) or by selecting a dot. Also shown is a present NFT button. The present NFT button sends a message to the NFT delivery server to indicate that the selected NFT (the NFT with the digital content displayed) is to be downloaded and displayed on a display connected to the NFT display device.

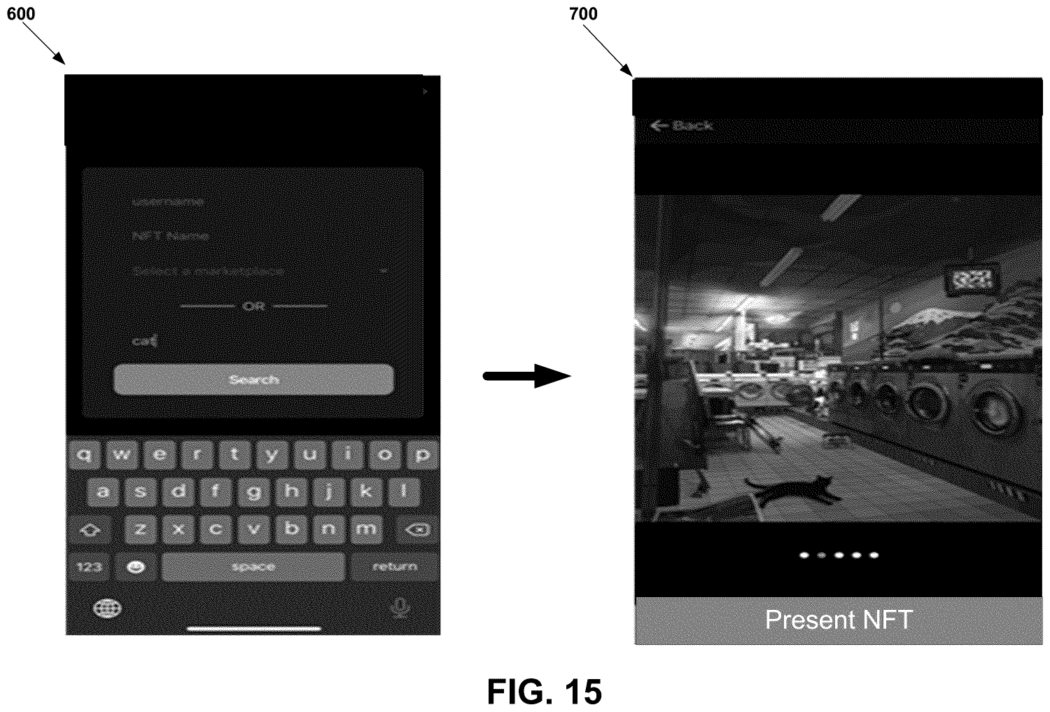

FIG. 15 illustrate example user interfaces 600 and 700 showing the navigation between the search page and display page, as part of the mobile NFT display application. In the example shown, a user entered a keyword search for “cat” at the user interface 600. When the user selects the search button the user interface 700 is presented to the user. The user interface 700 shows multiple NFTs (represented by the dots). The user can view and navigate between the NFTs returned as part of the search. When the present NFT button is selected the NFT associated with the digital content currently displayed to the user is selected to be downloaded at the NFT display device and displayed on a connected display. Also shown on the user interface 700 is a back button which is used to navigate back to the search page.

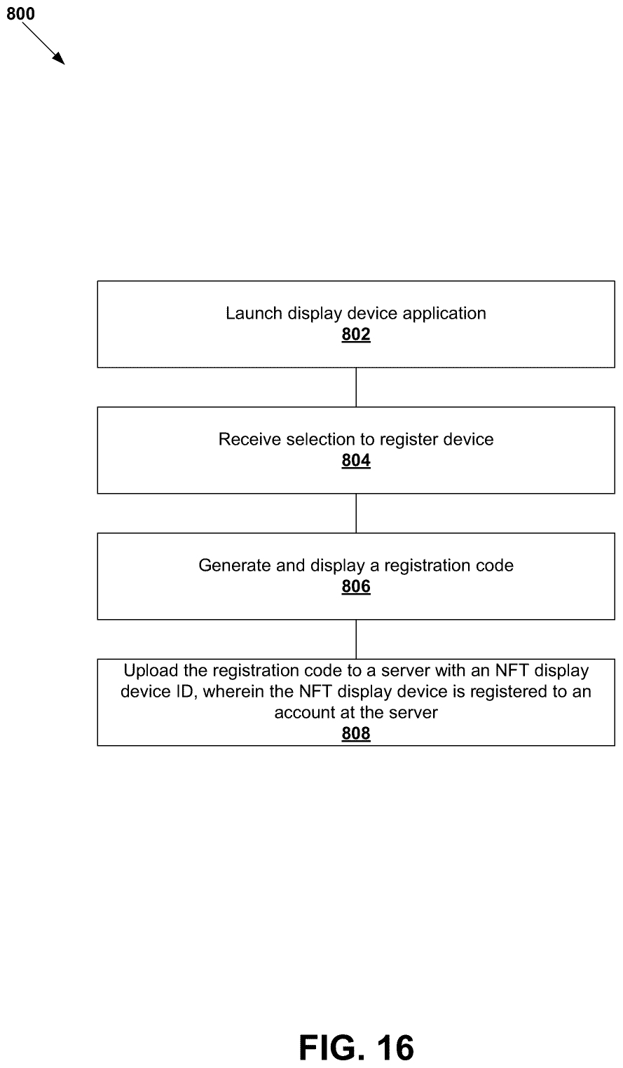

FIG. 16 illustrates an example method 800 for registering an NFT display device 110. Examples of the NFT display device 110 are illustrated and described in reference to FIGS. 1 and/or 2. The method 800 includes the operation at 802, 804, 806, and 808, and 810.

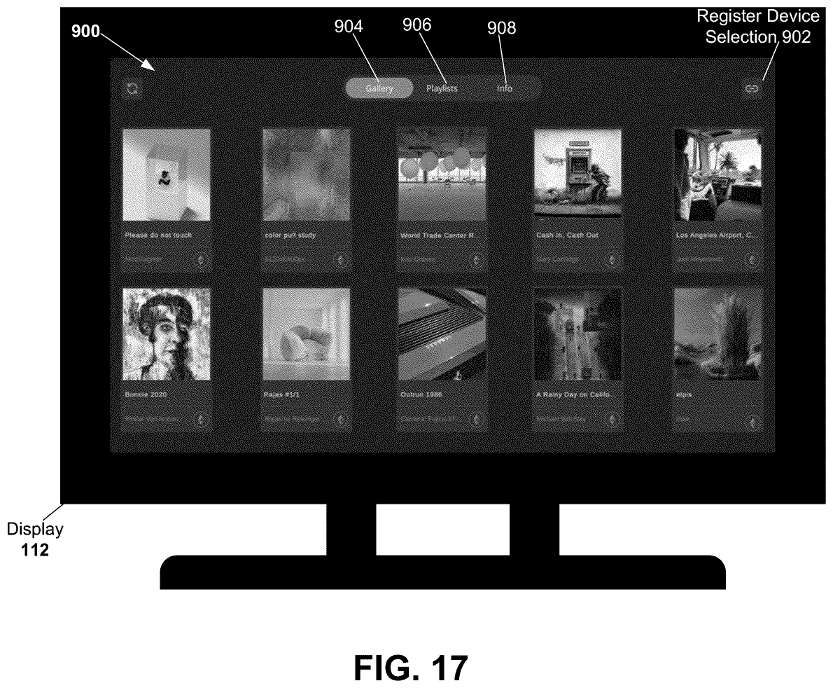

The operation 802 launches a display device application. In some embodiments, the launching the display device application presents the user interface 900 illustrated and describe in FIG. 17.

The operation 804 receives a selection to register the NFT display device 110. In some embodiments, the user selects the register device selection 902 illustrated on the user interface 900 in FIG. 17.

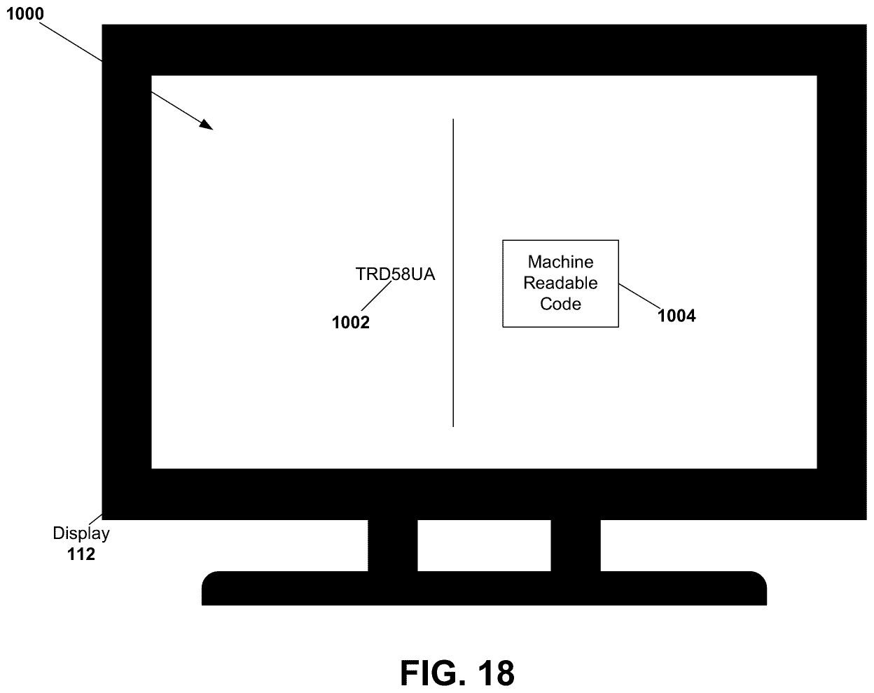

The operation 806 generates and displays a registration code. In some embodiments, the registration code is a random string of characters. An example user interface 1000 displaying the registration code 1002 is illustrated and described in FIG. 18.

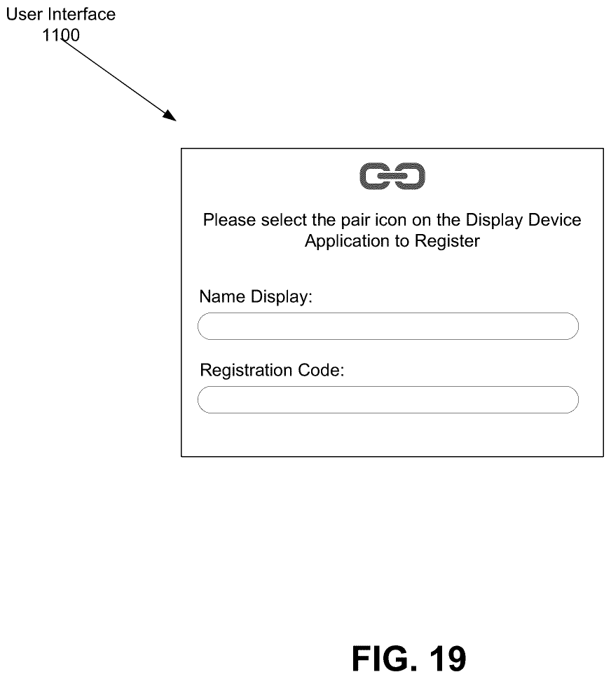

The operation 808 uploads the registration code with an NFT display device ID to a server, wherein the NFT display device is registered to an account at the server. In some embodiments, a user logins on a user device and enters the registration code (e.g., at the user interface 1110 illustrated and described in reference to FIG. 19) and sending a message to the server with the registration code, thereby associating a user account with NFT display device and completing the registration of the NFT display device.

Registering an NFT display device enables the NFT display device to receive a present NFT request and, in response to receiving the present NFT display request, display a digital file associated with the NFT. In some embodiments, the method 800 is implemented as instructions stored on an NFT display, when executed by a processor of the NFT display device, cause the NFT display device to perform some or all of the operations 802, 804, 806, 808, and/or 810.

FIG. 17 illustrates an example user interface 900 of the display device application. An example of the display device application 146 is illustrated and described in reference to FIG. 2. In the example shown, the user interface 900 is displayed on a display 112. In typical embodiments, an NFT display device is electrically connect to the display 112. In some embodiments, the display includes a processor, a memory, and/or storage, integrated within the display and configured to store and execute the display device application 146.

The user interface 900 includes a register device selection 902. When the register device selection 902 is selected initiates a process to register the NFT display device. For example, by performing the method 800 illustrated and described in reference to FIG. 16.

The user interface 900 includes a gallery tab 904, a playlist tab 906, and an information tab 908. The gallery tab 904 displays a plurality cards each corresponding to an NFT. Each card includes an NFT name, owner, link to view information about the NFT (e.g., a link to an etherscan.io webpage associated with the NFT), and a digital file of the NFT.

The playlist tab 906 displays selectable playlists comprising a plurality of NFTs. In some embodiments, the playlists are curated by an admin user. In some embodiments, the playlists are created by users and can be set for private or public. In some embodiments, a set of playlists are premium and require a user to have access to view the playlist (e.g., by paying a fee and/or subscription). In some embodiments, a playlist may include digital files which are optimized for a certain size, type, or orientation of display.

The information tab 908 includes information about the display device application. In some embodiments, the information tab 908 includes instructions for pairing a user device with the NFT display device.

FIG. 18 illustrates an example user interface 1000 of the display device application for registering an NFT display device. In some embodiments, the user interface 1000 is displayed in response to a receiving a selection of the register device selection 902 on the user interface 900 illustrated and described in reference to FIG. 17. In the example shown, the user interface 1000 is presented on the display 112 as part of the display device application. In some embodiments, the user interface 1000 presents a registration code 1002, which a user enters on a user device to register the NFT display device. In some embodiments, the user interface 1000 displays a machine readable code 1004. In some embodiments, the machine readable code includes an encoded URL linking to web application for the mobile NFT display application. In some embodiments, the machine readable code 1004 links to a webpage for registering the NFT display device. In some of these embodiments, the machine readable code may further include a registration code which is automatically entered at the webpage for registering the NFT display device.

FIG. 19 illustrates an example user interface 1100 of the mobile NFT display application for registering an NFT display device. In some embodiments, the user interface is presented on a user device of a user logged in to a user account. The user interface 1100 is configured to receive inputs to register an NFT display device with the user's account. In some embodiments, the user enters a name for the display and a registration code (e.g., the registration code 1002 shown in FIG. 18).

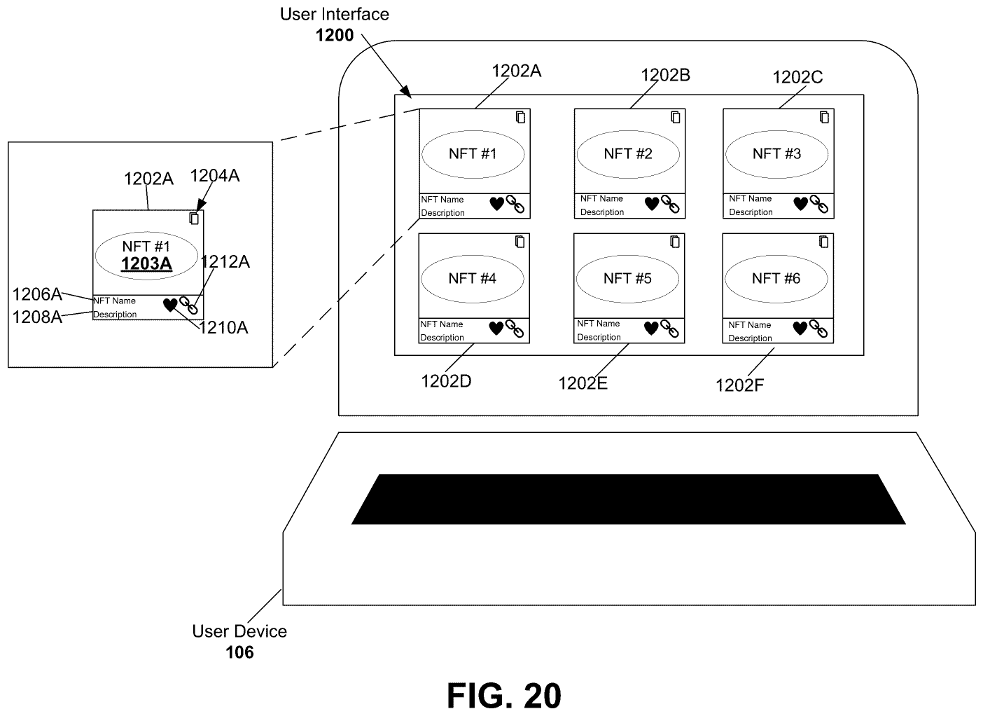

FIG. 20 illustrates an example user interface 1200 of the mobile NFT display application, in accordance with some embodiments of the present disclosure. In the example shown, the user interface 1200 is displayed on a user device 106. The user interface displays a plurality of cards 1202A-F. Each card presents a digital file 1203A associated with an NFT, a save input 1204, an NFT name 1206A, an NFT description 1208A, a favorite selection 1210A, and a link selection 1212A. When selected, the save input 1204A saves the NFT to a library associated with the user account. In some embodiments, the save input 1204A allows a user to add the NFT to a playlist. The favorite selection 1210A allows a user to favorite an NFT. In some embodiments, favorited NFTs are shown in a profile for the User on the user device (e.g., on a web application) and the NFT display device (on the display device application). For example, favoriting an NFT is saved with the user account on the server such that the favorited NFT will appear in favorites section for the user on either user devices logged into the mobile NFT display application or on registered NFT display devices. The link selection may link to a webpage providing information about the NFT (e.g., such as an etherscan.io webpage). In some embodiments, a user selects one of the plurality of cards 1202A-F to launch the user interface 1300 with the NFT corresponding to the selected card.

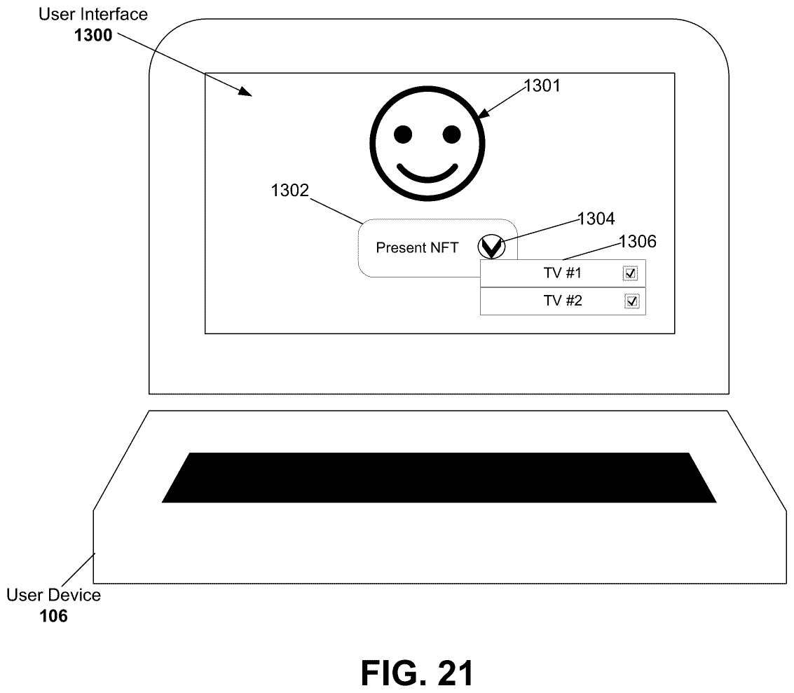

FIG. 21 illustrates an example user interface 1300 for selecting a registered NFT display device to send a present NFT request, in accordance with some embodiments of the present disclosure. The user interface 1300 is presented on the user device 106. The user interface displays a digital file 1301 associated with an NFT, a selection 1302 to send a request to present an NFT, and a drop down menu selection 1304. The drop down menu selection 1304 displays a list 1306 of registered NFT display devices when selected. A user can select one or more registered display devices and when the user selects the selection 1302 to send a request to present an NFT the user device sends a message to present the NFT on each of the selected NFT display devices. In some embodiments, the message is sent to each of the selected NFT display devices via the NFT delivery server. In some embodiments, the user device can send the message when at a separate geographic location from the NFT display device via a public network, such as the Internet. The user interface 1300 is another example of the user interface 700 illustrated and described in reference to FIG. 14.

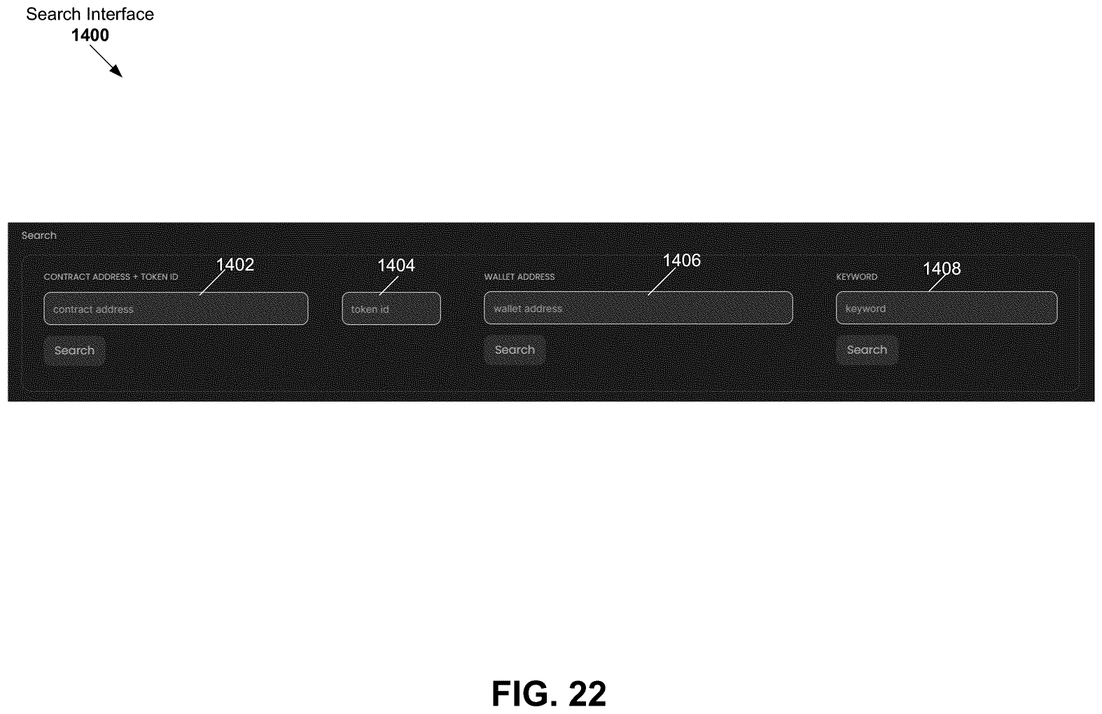

FIG. 22 illustrates an example search interface 1400 for entering an NFT search query, in accordance with some embodiments of the present disclosure. The search user interface allows a user to search by a contract address of an NFT at 1402, by a token ID of the NFT at 1404, by a wallet address at 1406, and by a keyword at 1408. Examples for searching by keyword are disclosed herein.

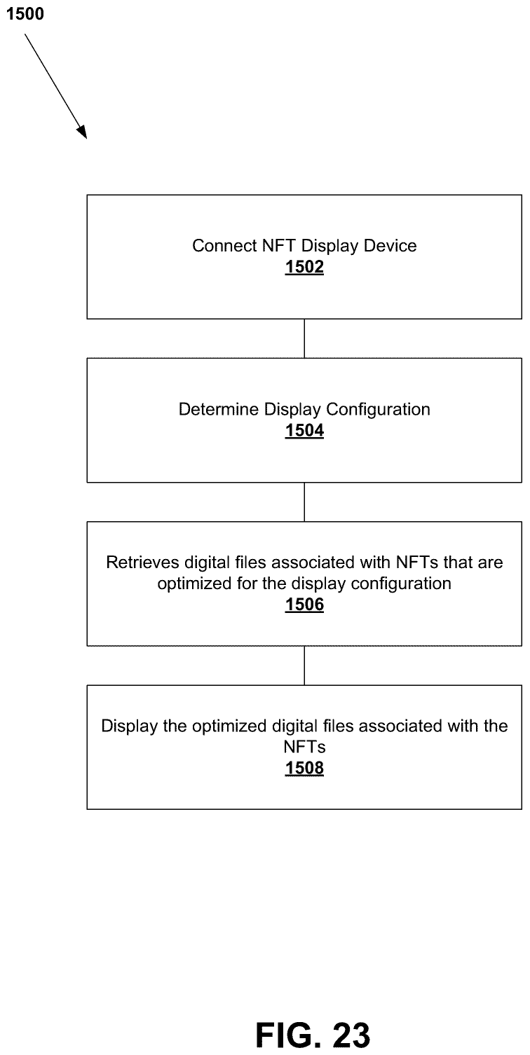

FIG. 23 illustrates an example method 1500 for displaying digital files associated with an NFT that are optimized for a display configuration, in accordance with some embodiments of the present disclosure. The method 1500 includes the operations 1502, 1504, 1506, and 1508.

The operation 1502 connects the NFT display device to a display. In some embodiments, the NFT display device is connected to the display via an interface, such as HDMI. The operation 1504 determines a display configuration. In some embodiments, the display configuration includes at least one of a display size, resolution and orientation (e.g., landscape/portrait). In some embodiments, the NFT display device includes a sensor to detect an orientation. In some embodiments, the display configuration is determined via messages sent via the interface connecting the NFT display device and the display device. The operation 1506 retrieves digital files associated with NFTs that are optimized for the display configuration. For example, if the display is determined to be in portrait mode, then digital files with images in portrait mode may be retrieved. In some embodiments, the database storing the NFTs includes tags assigned to the NFT which indicate configurations correspond to the associated digital file. The operation 1508 displays the optimized digital files associated with the NFT. In some embodiments, the images may be presented as part of a playlist where the image is updated periodically at a predetermined or configured time period.

Embodiment 1 is a method for presenting a non-fungible token (NFT), the method comprising: pairing a user device with an NFT display device; sending a query for one or more NFTs to an NFT delivery system, the NFT delivery system storing an NFT database, each of the one or more NFTs being associated with a digital file; receiving the associated digital files of the one or more NFTs in response to searching the NFT database with the query; receiving inputs selecting a particular NFT associated with a particular digital file from the one or more NFTs and selecting to send the particular NFT to the NFT display device; and sending instructions to the NFT display device to download the particular digital file from an NFT delivery server and display the particular digital file on the NFT display device.

Embodiment 2 is the method of embodiment 1, wherein pairing the user device with the NFT display device further comprises: receiving the NFT display device ID, a network ID for a network accessible by the NFT display device, and a network password for the network; sending a message to the NFT display device using the NFT display device ID with the network ID and the network password to allow the NFT display device to connect to the network.

Embodiment 3 is the method of embodiment 2, wherein the message is sent over a second network.

Embodiment 4 is the method of embodiment 3, wherein the second network is a cellular network and the network is a Wi-Fi network.

Embodiment 5 is the method of any of embodiments 1 through 4, wherein the query can include one or more of: (1) an owner name; (2) an NFT name; and (3) one or more keywords describing features which may be present in the NFT.

Embodiment 6 is a user device, the user device comprising: at least one processor; and one or more memory devices storing instructions which when executed by the at least one processor, cause the user device to: pair a user device with an NFT display device; send a query for one or more NFTs to an NFT delivery system, the NFT delivery system storing an NFT database, each of the one or more NFTs being associated with a digital file; receive the associated digital files of the one or more NFTs in response to searching the NFT database with the query; receive inputs selecting a particular NFT associated with a particular digital file from the one or more NFTs and selecting to send the particular NFT to the NFT display device; and send instructions to the NFT display device to download the particular digital file from an NFT delivery server and display the particular digital file on the NFT display device.

Embodiment 7 is a method for providing an NFT delivery service, the method comprising: receiving an NFT query request for an NFT database storing information for a plurality of NFTs, each of the plurality of NFTs is associated with a digital file; searching the NFT database with the query request for one or more NFTs; receiving a selection request of a particular NFT of the one or more NFTs; and sending the digital file associated with the particular NFT to an NFT display device.

Embodiment 8 is the method of embodiment 7, the method further comprising: retrieving a current owner of the particular NFT, and a link to the current owner's NFT collection; encoding the link in a machine readable code; and sending the digital file with the machine readable code overlayed at least a portion of the digital file.

Embodiment 9 is the method of any of embodiments 7 through 8, the method further comprising: exposing an API accessible by a plurality of user devices and a plurality of NFT display devices, the API configured to: (1) receive a query from any of the plurality of user devices; and (2) receive a request to download an NFT from any of the plurality of NFT display devices.

Embodiment 10 is the method of any of embodiments 7 through 9, wherein the machine readable code is a quick response (QR) code.

Embodiment 11 is an NFT delivery server comprising: at least one processor; a data store with an NFT database storing information for a plurality of NFTs, wherein each NFT is associated with a digital file; and at least one memory device, the at least one memory device storing instructions which, when executed by the at least one processor, cause the NFT delivery server to: receive an NFT query request for the NFT database; search the NFT database with the query request for one or more NFTs; receive a selection request of a particular NFT of the one or more NFTs; and send the digital file associated with the particular NFT to an NFT display device.

Embodiment 12 is the NFT delivery server of embodiment 11, wherein the NFT database stores one or more keywords associated with each of the plurality of NFTs.

Embodiment 13 is the NFT delivery server of embodiment 12, wherein to compile the one or more keywords includes to: retrieve NFT information from one or more NFT exchanges; web scrape web pages containing NFT information; receive user inputs describing NFT; use of a machine learning techniques to process the digital files associated with the NFTs; use of a computer vision algorithm to detect features in the digital files associated with the NFTS; and process the metadata associated with the NFTs or with the associated digital files.

Embodiment 14 is a method for presenting an NFT, the method comprising: receiving a command from a user device to connect to a network; accessing an NFT delivery server via the network; receiving a request to download a digital file associated with an NFT; and downloading and displaying the digital file on a connected display device.

Embodiment 15 is the method of embodiment 14, wherein the connected display device is a television that is connected via an HDMI interface.

Embodiment 16 is the method of any of embodiments 14 through 15, the method further comprising: checking, periodical, the NFT delivery server to determine if there is a new NFT is set to display; and display the new NFT in response to determining that the new NFT is set to display.

Embodiment 17 is the method of any of embodiments 14 through 16, wherein the command from the user device is reeved from a second network.

Embodiment 18 is the method of embodiment 17, wherein the second network is a cellular network and the network is a Wi-Fi network.

Embodiment 19 is an NFT display device comprising: a digital content interface; a processor; and a memory storing instructions which, when executed by the processor, cause the NFT display to: receive a command from a user device to connect to a network; access an NFT delivery server via the network; receive a request to download a digital file associated with an NFT; and download and display the digital file on a connected display device.

Embodiment 20 is the NFT display device of embodiment 19, wherein the digital content interface is an HDMI interface.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method for presenting a non-fungible token (NFT), the method comprising:
pairing a user device with an NFT display device;
sending a query for one or more NFTs to an NFT delivery system, the NFT delivery system storing an NFT database, each of the one or more NFTs being associated with a digital file;
receiving the associated digital files of the one or more NFTs in response to searching the NFT database with the query;
receiving inputs selecting a particular NFT associated with a particular digital file from the one or more NFTs and selecting to send the particular NFT to the NFT display device; and
sending instructions to the NFT display device to download the particular digital file from an NFT delivery server and display the particular digital file on the NFT display device.

2. The method of claim 1, wherein pairing the user device with the NFT display device further comprises:
receiving a NFT display device ID, a network ID for a network accessible by the NFT display device, and a network password for the network; and
sending a message to the NFT display device using the NFT display device ID with the network ID and the network password to allow the NFT display device to connect to the network.

3. The method of claim 2, wherein the message is sent over a second network.

4. The method of claim 3, wherein the second network is a cellular network and the network is a Wi-Fi network.

5. The method of claim 1, wherein the query can include one or more of:
(1) an owner name;
(2) an NFT name; and
(3) one or more keywords describing features which may be present in a desired NFT.

6. The method of claim 1, wherein the NFT delivery system provides an NFT delivery service by
receiving the query for the one or more NFTs;
searching the NFT database with the query for the one or more NFTs;
receiving the inputs selecting the particular NFT of the one or more NFTs; and
sending the digital file associated with the particular NFT to the NFT display device.

7. The method of claim 6, wherein the NFT delivery system further provides the NFT delivery service by:
retrieving a current owner of the particular NFT, and a link to a NFT collection associated with the current owner;
encoding the link in a machine readable code; and
sending the digital file with the machine readable code.

8. The method of claim 6, wherein the NFT delivery system further provides the NFT delivery service by:
exposing an application programming interface (API) accessible by a plurality of user devices and a plurality of NFT display devices, the API configured to:
(1) receive queries from any of the plurality of user devices; and
(2) receive a request to download an NFT from any of the plurality of NFT display devices.

9. The method of claim 7, wherein the machine readable code is a quick response (QR) code.

10. The method of claim 1, wherein the NFT display device is connected to a display device via an HDMI interface.

11. The method of claim 1, the method further comprising:
checking, periodically, the NFT delivery server to determine if there is a new NFT is set to display; and
display the new NFT in response to determining that the new NFT is set to display.

12. An NFT presentation system comprising:
a user device having:
at least one processor; and
one or more memory devices storing instructions which when executed by the at least one processor to execute a mobile NFT display application; and
an NFT display device having:
a digital content interface;
a processor; and
a memory storing instructions which, when executed by the processor, cause the NFT display device to execute a display device application;
wherein the user device and the NFT display device are configured to pair by entering a registration code, generated at the NFT display device, at the user device to create an association and registering the association at a NFT delivery system, thereby allowing the user device to send instructions via the NFT delivery system to the NFT display device to display a digital file associated with a selected NFT.

13. The NFT presentation system of claim 12, wherein the mobile NFT display application is configured to:
send a query for one or more NFTs to the NFT delivery system, the NFT delivery system storing an NFT database with the one or more NFTs and associated digital files;
receive the associated digital files of the one or more NFTs in response to searching the NFT database with the query; and
receive inputs selecting the selected NFT and send the selected NFT to the NFT display device.

14. The NFT presentation system of claim 12, wherein the display device application is configured to:
receive a command from the user device to connect to a network;
access the NFT delivery system via the network;
receive a request to download a particular digital file associated with a particular NFT; and
download and display the digital file on a connected display device.

15. The NFT presentation system of claim 12, wherein the digital content interface is an HDMI interface.

16. The NFT presentation system of claim 12, wherein the NFT display device is configured to:
determine an orientation of a connected display device;
retrieve at least one digital file associated with an NFT based at least in part on the orientation of the connected display device; and
display the at least one digital file.

17. An NFT delivery server comprising:
at least one processor;
a data store with an NFT database storing information for a plurality of NFTs, wherein each NFT is associated with a digital file; and
at least one memory device, the at least one memory device storing instructions which, when executed by the at least one processor, cause the NFT delivery server to:
receive an NFT query request for the NFT database;
search the NFT database with the NFT query request for one or more NFTs;
receive a selection request of a particular NFT of the one or more NFTs; and
send the digital file associated with the particular NFT to an NFT display device.

18. The NFT delivery server of claim 17, wherein the NFT database stores one or more keywords associated with each of the plurality of NFTs.

19. The NFT delivery server of claim 18, wherein to compile the one or more keywords includes to:
retrieve NFT information from one or more NFT exchanges;
web scrape web pages containing NFT information;
receive user inputs describing at least one of the one or more NFTs;
use of a machine learning techniques to process the digital files associated with the one or more NFTs;
use of a computer vision algorithm to detect features in the digital files associated with the one or more NFTS; and
process metadata associated with the one or more NFTs or with the associated digital files.

20. The NFT delivery server of claim 17, wherein the NFT delivery server is configured to track a number of views for the one or more NFTs and providing payment to an owner of an NFT when the number of views for the NFT exceeds a threshold.
